(19) United States
(12) Patent Application Publication
(10) Pub. No.: US 2024/0426617 A1
(43) Pub. Date: Dec. 26, 2024

(54) CHARTER VEHICLE ROUTING AND TRACKING IN A FLEET ROUTING SYSTEM

(71) Applicant: ZUM SERVICES, INC., Redwood City, CA (US)

(72) Inventors: Himanshu Arora, Redwood City, CA (US); Rohit Jain, Redwood City, CA (US); Andrew Mormysh, Redwood City, CA (US); Sreejith Nair, Redwood City, CA (US); Melissa Shiu, Redwood City, CA (US)

(73) Assignee: ZUM SERVICES, INC., Redwood City, CA (US)

(21) Appl. No.: 18/212,622

(22) Filed: Jun. 21, 2023

(51) Int. Cl. G01C 21/34; G01C 21/36; G06Q 50/30

(52) U.S. Cl. CPC G01C 21/343; G01C 21/3446; G01C 21/3632; G01C 21/3697; G06Q 50/40

(57) ABSTRACT

A system includes a server device which receives a charter service request from a user device is provided herein. The vehicle charter service request includes information about the request including a specified pickup location, one or more specified stop locations, and a specified destination location. The server device may provide a graphical user interface for the one or more vehicle types which are selectable for providing the vehicle charter service. The server device creates an optimized route for the charter service based on the specified pickup location, one or more specified stop locations, and a specified destination location. The server device may further provide a map and real time tracking for a vehicle providing the charter service.

### TECHNICAL FIELD

The present application discloses a system for routing a fleet of vehicles, scheduling stops, and optimizing those routes and stops based on one or more elements of primary concern. In particular, the present application provides routing, ride monitoring, and tracking for privately scheduled charter vehicle.

### BACKGROUND

The earliest advent of a fleet of vehicles likely dates back to antiquity when vehicles became necessary for the transport of people and goods. Fleets of boats are known to have existed in ancient Greece while fleets of chariots were known to have been used in ancient wars both as vehicles of war and as transport vehicles for soldiers and supplies. Even horses themselves have been used for the purpose of transporting people and goods. Indeed, many ancient stories of certain battles turn on the use of fleets of vehicles and their relative coordination in both timing and goals to the win or loss of a battle.

In the more recent past, trains, sail powered boats, and ocean liners were assembled into fleets for both military and civilian use. Since trips across continents or across oceans were typically of an extended duration, schedules and stops for these vehicles, especially in the context of civilian use, were published well in advance of an actual date of embarkation. These dates and schedules were largely accurate given the need to be at a next stop or location in a certain amount of time. Many ocean liners, for example, stopped in multiple ports to pick up passengers and goods before transporting both across the ocean. Trains kept a specific schedule on a time duration basis. For example, a train may leave from Paris for Berlin every other day allowing time for a day to make the trip from Paris to Berlin and a day to make the trip back. At the same time, other trains may have traveled from Trenton, New Jersey to New York City, New York several times per day. Historically, these schedules were based on the number of vehicles available and on the travel time necessary for trips between stops.

The advent of the modern automobile changed transportation all across the world on seemingly an overnight basis, at least in retrospect. Motorized land based transportation without the aid of rails made automobiles the transport method of choice for anything that was not too heavy or far away. Trucks could easily carry people and goods over short distances with very little notice, which was a major development for transportation. Buses became the vehicle of choice for transporting people as buses were fitted with seats for people. Trucks became the vehicle of choice for transporting goods from one place to another. As the relative prices of automobiles decreased and World Wars broke out, automobile fleets came into existence. Fleets of buses took passengers to places where rails did not exist while fleets of trucks took goods from boats in the harbor to soldiers fighting inland.

Fleet logistics became an issue of major importance to military and civilian fleet owners alike. It became imperative to ensure that certain vehicles were available for certain transportation tasks on a periodic basis, whether that basis was a multiple times per day basis, a day to day basis, a weekly basis, or some other periodic basis. Automobiles became different from fleet vehicles such as trains, boats, and other ocean going vessels because automobiles could schedule multiple trips per day while making repeated visits to a logistical hub or supply center. The pace at which trucks could supply goods outstripped anything that was previously known to human civilization and made the delivery of goods possible at scale. Buses developed scheduled times and routes for conveying passengers along certain routes at certain times.

Today, massive fleets of vehicles are owned by both governmental and private institutions to facilitate the transport of goods and passengers, which is a major logistics endeavor. Fleet vehicles may have routes which are traveled on a periodic basis to serve customers in various capacities. For example, mail is delivered to virtually every home in the United States on a daily basis by mail carriers in individual trucks. Other private mail or companies and goods delivery companies also have fleets of trucks to provide mail service for individual customers. Similarly, local governmental entities operate bus lines for mass transit of passengers, typically in and out of big cities. Public bus lines, for example, use main routes with spurs that serve residential areas of a city to facilitate passengers traveling into and out from the city on a daily basis. Both public and private schools operate bus lines to safely transport children to and from school on a daily basis. School buses, however, usually operate based on stopping at certain places at certain times to safely load children to attend local schools and, for that reason, travel routes that are based on where children live, generally speaking.

Logistics for these fleets are incredibly complex, which has been a persistent problem since antiquity. Horse cavalry attacking at the wrong time on an ancient Greek battlefield and buses arriving off schedule are different implementations of the same problem spread thousands of years apart. Maintenance, location, routing, fueling, and driver support are also considerations for fleet vehicles in order to deliver passengers or goods to a particular place by a particular time. In the context of school buses, a bus may be late because of a breakdown, construction delays, fuel problems, or a missing driver which may cause a child to be late for school. Further, school buses may serve redundant routes, which could be accommodated by a single bus, which increases the relative costs of providing bus services on virtually a daily basis. Those costs may include pollution due to emissions, fuel costs, driver costs, costs in time, and others. Current solutions are not only inefficient but wasteful and contribute to cumulative emissions based environmental harm. Optimization is needed to reduce financial, pollution, and time costs in fleet vehicle use and routing.

It is, therefore, one object of this disclosure to provide a user interface that facilitates a routing system which optimizes routes for fleet vehicles. It is another object of this disclosure to provide a charter vehicle service which allows a user to identify a location and number of stops. It is a further object of this disclosure to provide a charter vehicle service that provides real time tracking for the charter bus service.

### SUMMARY OF THE DISCLOSURE

A system includes a server device which receives a charter service request from a user device is provided herein. The vehicle charter service request includes information about the request including a specified pickup location, one or more specified stop locations, and a specified destination location. The server device may provide a graphical user interface for the one or more vehicle types which are selectable for providing the vehicle charter service. The server device creates an optimized route for the charter service based on the specified pickup location, one or more specified stop locations, and a specified destination location. The server may further provide a graphical user interface to the user device which provides a map that includes a visual representation of the route, the specified pickup location, the one or more specified stop locations, and the specified destination location. The server device may identify, for the user device, one or more vehicle types selected for providing the vehicle charter service and a driver available for serving the optimized route. The server device may provide the optimized route via a graphical user interface to a driver device which includes visual representations of the optimized route, the specific pickup location, the specified one or more stops, and the specific destination. The server device may further provide a map and real time tracking for a vehicle providing the charter service to the user device and the driver device.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIG. 1 illustrates box diagram of a fleet routing system.

FIG. 2 illustrates an exemplary user interface for requesting a charter bus.

FIG. 3 illustrates an exemplary user interface for selecting a charter vehicle.

FIG. 4 illustrates an exemplary user interface for charter service confirmation, with optimized routing.

FIG. 5 illustrates an exemplary user interface for assigning a vehicle for the charter service.

FIG. 6 illustrates a user interface providing real time tracking information about the charter service.

### DETAILED DESCRIPTION

The disclosure extends to vehicles of all types which are assembled into a fleet for a common purpose or goal such as, but not limited to, delivering passengers, delivering goods, or any other purpose.

In the following description of the disclosure, reference is made to the accompanying drawings, which form a part hereof, and in which are shown by way of illustration specific implementations in which the disclosure is may be practiced. It is understood that other implementations may be utilized, and structural changes may be made without departing from the scope of the disclosure.

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

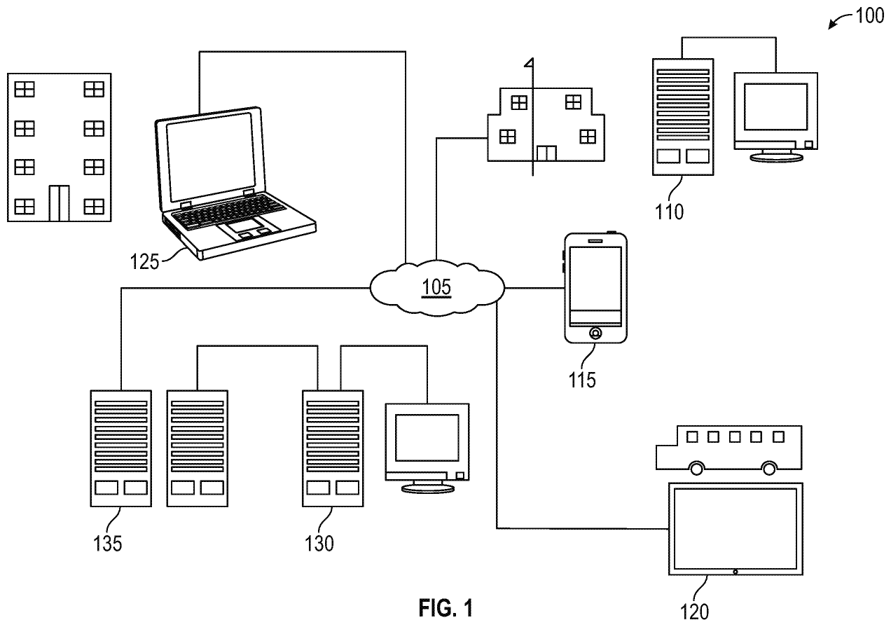

FIG. 1 illustrates a box diagram of a fleet routing system 100. Fleet routing system may be implemented by use of a communications network 105 such as the Internet, which facilitates the exchange of information between various devices within fleet routing system 100. Fleet routing system may be used with any fleet but is described with respect to a fleet of school buses. The techniques disclosed herein may be used to deliver passengers or goods with little or no modification. Fleet routing system 100 may be implemented between a ride requestor device, such as a school device 110 (and/or an administration level device 125, which will be discussed below) and a user device 115, and a driver device 120 associated with a bus driver, for example. Fleet routing system 100 may be implemented by an administrator device 125. A provider may provide the administrator device 125 or the ride requestor device 110 with access to fleet routing system 100 by use of servers 135 and provider device 130. In one implementation, a school district may use administration level device 125 which provides buses to pick up and deliver children to a school and operate in a manner similar to ride requestor device 110. In other embodiments, ride requestor device 110 may be implemented to schedule routing for bus routes for a particular school. In other words, various levels of administration may access and implement fleet routing system 100 according to their particular needs for the delivery of passengers.

At the outset, a provider device 130 may give a ride requestor device 110 or an administrator level device 125 access to fleet routing system 100 by servers 135 to create bus routing for a particular school district or school as appropriate. Servers 135 may provide a user interface to ride requestor device 110 or an administrator level device 125 to create routes for each child in the district or school as appropriate. For example, a profile may be created for each child in the district or school as appropriate to be stored in non-volatile non-transitory storage media, which includes a home address for each child. In response, fleet routing system 100 may determine a distance between identified stops and a travel time between each of those identified stops to determine both a single bus route and a number of buses required for a necessary number of routes. For example, based on a standard bus configuration, a school bus may transport 80 seated students. However, due to time and distance constraints, a certain bus may only be able to pick up 45 students at identified stops. The identified stops may be based on ensuring a child does not cross a road or lives within a certain distance of the identified stop. If one location is heavily populated with children who need to board a school bus, optimized routing may determine that since more children are boarding per identified stop, that particular school bus may need less time to complete an assigned route. In one embodiment, fleet routing system 100 may optimize routes based on the shortest time on the road for each bus, based on minimal fuel usage across the fleet, based on minimal emissions across the fleet, based on or any other basis that is meaningful to the school or community served by the school.

Once the routes are generated with children assigned to a particular bus, server 135 may transmit bus information to user device 115 by fleet routing system 100. Bus information may include bus stop information for picking up a child and a time for pick up at the bus stop. User device 115 may be associated with the child bus rider or with a parent of the child bus rider. User device 115 may be implemented as separate devices where one device is associated with the child rider and another device is associated with a parent, guardian, or other supervisor of a child. When the school bus is operating, a real time location may be provided to user device 115 so that the child and child supervisor may identify where the bus is currently located. A child or child supervisor may use user device 115 to create the child profile discussed above by providing information from user device 115 through communications network 105 to server 135.

Further, once the routes are generated, server 135 may transmit individual route information to a bus driver via driver device 120, in fleet routing system 100. Individual route information may be a mandatory bus route for the driver to follow with a stop sequence that is identified along the individual route. Individual route information may include turn by turn instructions with expected drive time duration and distance for the bus driver. Driver device 120 may also detect information from a particular bus drive and provide that information to server 135 through communication network 135. Information provided from driver device 120 may include distance traveled information, fuel use information, pickup duration information, bus stop location information (e.g., information about where the stop is designated versus where the stop actually occurred), speed of travel information (in terms of actual speeding and in terms of slowdowns caused by traffic, construction, or any other road condition), rider verification information, rider disembarking information, and any other information that may be used by server 135 to optimize routing. In one embodiment, driver device 120 may receive an optimized route from server 135 for picking up children based on a home or a school address and/or prior pickup/drop off history locations for children on a particular route. In another embodiment, driver device 120 may further be optimized to prevent U-turns, enforce curbside pickup to avoid children crossing streets. Server 135 may receive information from driver device 120 which it may use to optimize routes based on learning from past driver routes to determine a best path between stops. Server 135 may receive information from driver device 120 which may optimize based on learned roadblocks and driver input to driver device 120 with new information (e.g., a street closure or construction) which causes server 135 to reoptimize the bus route. Server 135 may use information to determine and store driving instructions at the ride route level for a particular bus and driver device 120. Server 135 may track a bus via driver device 135 during a pickup or drop off ride and ensure compliance with the optimized route. If driver device 120 indicates that a bus is not following optimized route information, server 135 may send a message to ride requestor device 110, administrator device 125, or provider device 130 to allow either the ride requestor, the administrator, or the provider to contact the bus driver with route correction instructions.

Based on information received from driver device 120, server device 135 may maintain estimated global positioning system (“GPS”) waypoints and an estimated time of arrival (“ETA”) information for each ride, which may be constantly updated based on information provided by driver device 120. Driver device 120 may further provide real time routing, navigation, and path information based on a current location of driver device 120. Routing, navigation, and path information may be displayed on a screen associated with driver device 120. The user may receive, via user device 115, expected vehicle path information on a map displayed on a screen of user device 115. Thus, a user of user device 115 may be able to track bus 120 in real time and observe where a bus is currently and when a bus will be at a specific stop, which may be identified by waypoints provided to the user from server 135 via user device 115. Any data received from driver device 120 may be stored as historical data which may be used to further optimize bus routing on a permanent or temporary basis depending on road conditions, pickup/drop off requirements, and any other factor identified herein.

Ride requestor device 110, user device 115, driver device 120, administrator device 125, and provider device 130 may be implemented as any electronic device with processing power sufficient to share electronic information back and forth through communications network 105. Examples of ride requestor device 110, user device 115, driver device 120, administrator device 125, and provider device 130 include mobile phones, desktop computers, laptop computers, tablets, game consoles, personal computers, mobile devices, notebook computers, smart watches, and any other digital device that has the processing ability to interact with server 135.

Ride requestor device 110, user device 115, driver device 120, administrator device 125, and provider device 130 may include software and hardware modules that execute computer operations, communicate with communication networks 105 and server 135. Further, hardware components may include a combination of Central Processing Units (“CPUs”), buses, volatile and non-volatile memory devices, storage units, non-transitory computer-readable storage media, data processors, processing devices, control devices transmitters, receivers, antennas, transceivers, input devices, output devices, network interface devices, and other types of components that are apparent to those skilled in the art. These hardware components within ride requestor device 110, user device 115, driver device 120, administrator device 125, and provider device 130, are used to connect with server 135.

Server 135 may provide web-based access to fleet routing system 100 (or relevant portions based on which device is associated with a particular function—e.g., a parent using user device 115 may not have permissions to reroute buses) to ride requestor device 110, user device 115, driver device 120, administrator device 125, and provider device 130. Communication network 105 may be a wired, wireless, or both and facilitate communications in fleet routing system 100. Server 135 may include cloud computers, super computers, mainframe computers, application servers, catalog servers, communications servers, computing servers, database servers, file servers, game servers, home servers, proxy servers, stand-alone servers, web servers, combinations of one or more of the foregoing examples, and any other computing device that may be used to execute optimized routing and communication for web based fleet routing system 100. Server computer 135 may be implemented as one or more actual devices but are collectively referred to as server computer 135 may include software and hardware modules, sequences of instructions, routines, data structures, display interfaces, and other types of structures that execute server computer operations. Further, hardware components may include a combination of Central Processing Units (“CPUs”), buses, volatile and non-volatile memory devices, storage units, non-transitory computer-readable storage media, data processors, processing devices, processors, control devices transmitters, receivers, antennas, transceivers, input devices, output devices, network interface devices, and other types of components that are apparent to those skilled in the art. These hardware components within one or more server 135 may be used to execute the various methods or algorithms disclosed herein, and interface with ride requestor device 110, user device 115, driver device 120, administrator device 125, and provider device 130.

In one embodiment, ride requestor device 110, user device 115, driver device 120, administrator device 125, and provider device 130 may access server 135 by a communication network 105. In each case, wireless communication network 135 connects ride requestor device 110, user device 115, driver device 120, administrator device 125, and provider device 130 via an internet connection provided by communication network 105. Any suitable internet connection may be implemented for wireless communication network 105 including any wired, wireless, or cellular based connections. Examples of these various internet connections include implementations using Wi-Fi, ZigBee, Z-Wave, RF4CE, Ethernet, telephone line, cellular channels, or others that operate in accordance with protocols defined in IEEE (Institute of Electrical and Electronics Engineers) 802.11, 801.11a, 801.11b, 801.11e, 802.11g, 802.11h, 802.11i, 802.11n, 802.16, 802.16d, 802.16e, or 802.16m using any network type including a wide-area network (“WAN”), a local-area network (“LAN”), a 2G network, a 3G network, a 4G network, a 5G network and its successors, a Worldwide Interoperability for Microwave Access (WiMAX) network, a Long Term Evolution (LTE) network, Code-Division Multiple Access (CDMA) network, Wideband CDMA (WCDMA) network, any type of satellite or cellular network, or any other appropriate protocol to facilitate communication between, ride requestor device 110, user device 115, driver device 120, administrator device 125, and provider device 130 and server 135.

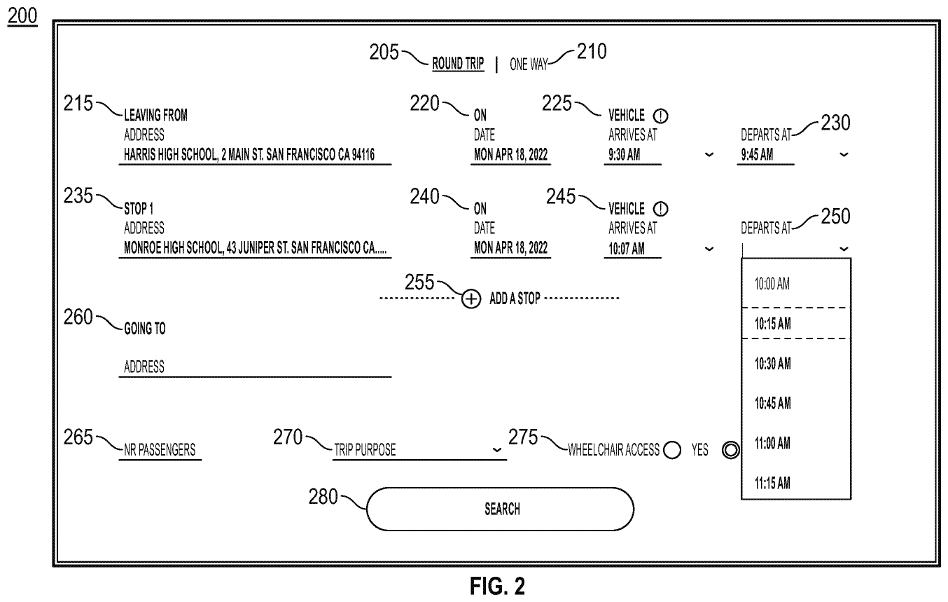

FIG. 2 illustrates an exemplary user interface 200 for requesting a charter vehicle service. A charter vehicle service may be a request for a vehicle that transports a group of passengers to, for example, field trips, athletic trips, mid-day trips, evening trips, after school trips, summer trips, weekend trips, and any other one-time trip that is otherwise not scheduled for repetition or frequency. A user may interact with user interface provided by server device 135 to, for example, user device 115. Server device 135 may, based on a user's instructions, cause user interface 200 to be displayed on user device 115 to facilitate a request for a charter vehicle service. User interface 200 may include a round trip button 205 or a one-way trip button 210. Round trip button 205 may allow the user to indicate that the user intends to use a charter vehicle to travel from a start location to a destination and return to the start location. One-way trip button 210 may allow the user to indicate that the user intends to use a charter vehicle to travel from a start location to a destination only, without a return trip.

User interface 200 may further provide a start location identification interface 215 which allows a user to input an address, through user device 115, that the user desires to be the start location for the charter vehicle service. User interface 200 may further provide a date interface 220 where the user can schedule the date of the charter vehicle service, an arrive time interface 225 where the user can identify a time for the charter vehicle to arrive, and a depart time interface 230, which is the intended time for departure of the charter vehicle.

User interface 200 may further allow a user to identify a stop location along the route. The stop location could be identified as a place for a break for the vehicle riders, may be scheduled as a stop to pick up additional riders, a stop to let riders off, or a stop to both drop some riders off and to pick up additional riders. User interface 200 provides a stop location identification interface 235 which allows a user to input an address, through user device 115, that the user desires to be a stop location for the charter vehicle service. User interface may further provide a date interface 240 where a user can schedule, via stop date interface 240 a date on which the stop may take place. Stop time interface 245 may be automatically populated by server device 135. Once server device 135 has obtained a start location through start location identification interface 215, and a stop location through stop location identification interface 235, server device 135 may determine an optimized route between the start location and the stop location, including an estimated time of arrival which may be automatically populated into stop time interface 245. User interface 200 may further allow a user to select a depart time in depart time information interface 250 which identifies a time that the stop at the stop location identified in stop location identification interface 235 ends.

User interface 200 further provides an add stop button 255. The add stop button may allow a user to provide information for a plurality of stops. While a stop is not necessary and stop location identification interface 235 is optional, it is also an option to create a plurality of stops by interacting with add stop button 255 to create a plurality of stop location identification interfaces 235, a plurality of date interfaces 240, a plurality of automatically populated stop time interfaces, and a plurality of depart time information interfaces. The user may create as many individual stops as desired.

User interface 200 further includes a destination identification interface 260 which may be the final point along the route. The user may, via user device 115, specify an address for destination identification interface 260 as a drop off location for the charter vehicles service. User interface 200 may further include a number of passengers interface 265 where a user may specify an expected number of passengers for the charter vehicle service. User interface 200 may further include a trip purpose interface 270 which allows a user to identify a purpose of hiring a charter service, whether it is for an extracurricular school activity, a civic activity, a private school activity, a church activity, a wedding or other private event, summer travel, athletics, motorcades, or any other activity that requires transportation for a significant number of passengers. A special needs interface 275 in user interface 200 may further specify to server 135 that the provided vehicle does or does not need wheelchair accommodations. Once user interface 200 has been populated with the requisite information, a user may search, via search button 280, for a charter vehicle that is available for the particular route on the particular date set forth by the user through user interface 200 displayed on user device 115.

Previous solutions for charter vehicles include requesting a quote for a particular vehicle to provide charter vehicle services between a start location and a destination without the option to create additional stops en route. One further consideration is that charter vehicles are provided with drivers who facilitate the particular charter service at least because charter vehicle drivers typically need, at least in the United States of America, a special driver's license that allows them to legally drive a charter vehicle. Thus, user interface 200 provides functionality that is different from conventional car rental, ride sharing services, or even charter service request interfaces.

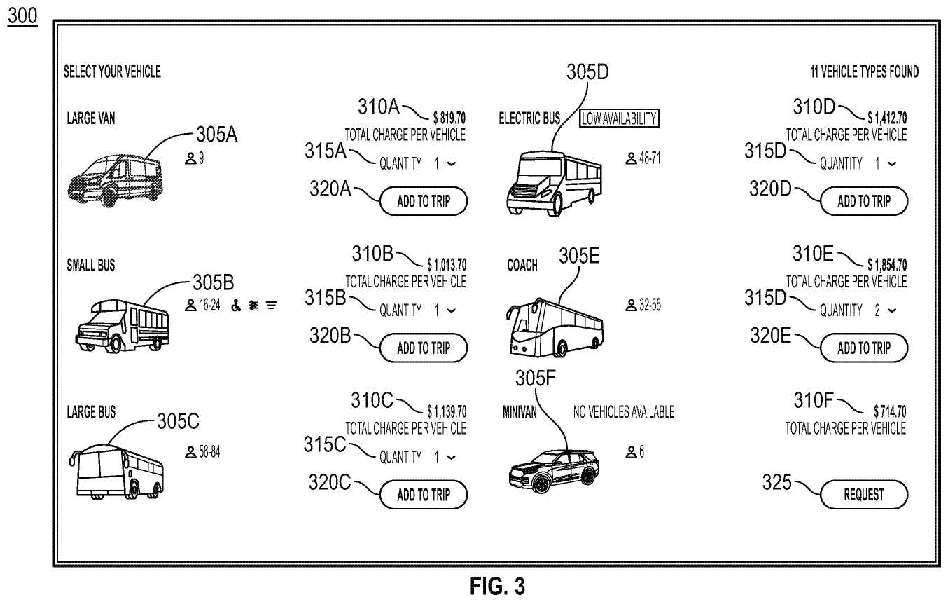

While not explicitly shown in FIG. 2, if a user selects a round trip via round trip button 205, a user may provide additional information about pickup times, depart times, a number of stops and a location of those stops via user device 115 through user interface 200. In other words, user interface 200 may be provided to the user for the user to provide information discussed above for a return trip. Furthermore, users may be specifically identified through fleet routing system 100 to provide service to certain entities at different pricing structures based on contractual obligations for providing ride services. For example, a user may be ride requestor interacting with user interface 200 via ride requestor device 110 or an administrator interacting with user interface 200 via administrator device 125. In some situations, a provider may help a customer facilitate a charter service by providing information into user interface 200 via provider device 130 as a service to particular customers. Any one of the foregoing users may further request that via a toggle button that the driver and the bus stay at the destination while the riders are at the activity, which will be reflected in the cost indicator for the service shown in FIG. 3.

FIG. 3 illustrates an exemplary user interface 300 for selecting a charter vehicle. Once a search is performed in user interface 200 by a user interacting with search button 280 via user device 115, user interface 300 may be provided for display by server 135 to user device 115. As shown in user interface 300, a plurality of vehicles such as a large van 305A, a small bus 305B, a large bus 305C, an electric bus 305D, a motorcoach 305E, and a minivan 305F may be selected as a vehicle for the charter service identified in user interface 100. In user interface 300, each one of vehicles 305A-305F may be identified with an identification of the number of passengers the vehicle can safely carry and a brief description of each vehicle. Vehicles 305A-305F may be multi-passenger vehicles capable of carrying 6 passengers, 9 passengers, 16 passengers, or more. User interface 300 may further provide a cost indicator 310A-310F for each one of vehicles 305A-305F.

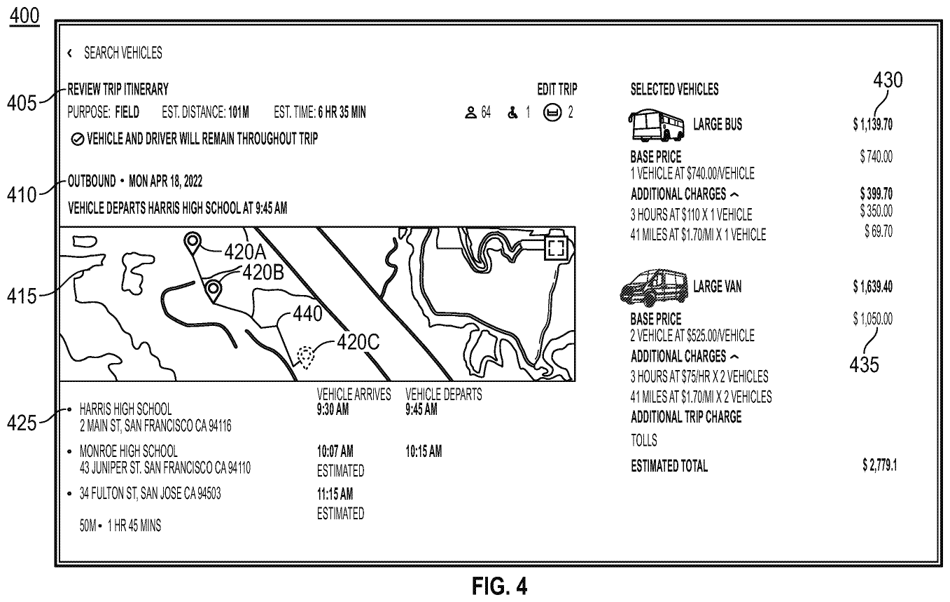

For example, as shown in user interface 300, a large bus 305C for the route specified in user interface 200, including one stop, may cost $1,139.70, for example, as shown in cost indicator 310-C. The user may further be able to specify a number of vehicles required to perform the route by quantity indicator 315A-315E. A user may be further provided, via user interface 300, with a selection indicator, 320A-320E, which allows a user to select a number of the available vehicles 305A-305E for the trip. As shown in FIG. 3, user interface 300 identifies minivan 305F as being unavailable for this trip by presenting a picture of vehicle 305F as being opaque to indicate that vehicle 305F is unavailable for this particular request, although a user may if desired, use a button 325 to request vehicle 305F if that is the user's desired vehicle of choice. Once a vehicle is selected, user interface 400 may be provided, as shown in FIG. 4.

FIG. 4 illustrates an exemplary user interface 400 for charter service confirmation, with optimized routing. User interface 400 is provided as a confirmation of a route itinerary based on information provided through user interface 200 and 300, as discussed above. For example, user interface 400 includes itinerary information 405, which may include a purpose specified for the trip in trip purpose interface 270 of user interface 200, an estimated mileage for the trip, which in the case of the information provided through user interface 200 is 1010 miles and an estimated duration for the trip of 6 hours and 35 minutes. Itinerary information may further include information about the number of passengers, number of wheelchairs, and number of stops.

User interface 400 may provide information 410 about an outbound trip and an inbound trip (e.g., a trip to the destination from the starting location and returning to the starting location from the destination). For explanatory purposes, only an outbound trip is provided as it is assumed that an inbound trip is identical in the case of the service request provided in user interface 200 of FIG. 2. However, this disclosure pertains equally to an outbound and inbound trip. As shown in user interface 400, the outbound trip begins on Monday, Apr. 18, 2022, specifies the location for departure and the time for departure. It is noted that the dates provided are based on test data for purposes of example and are not representative of actual trips that were provided.

User interface 400 may further provide a map 415 which illustrates a starting location 420A, a stop location 420B and a destination 420C along optimized route 440. Optimized route 440 may be identified by server device 135 using an artificial intelligence engine associated with server device 135 based on machine learning techniques. Server device 135 and artificial intelligence engine may be further informed by information provided to fleet routing system 100 by any driver device 120 associated with fleet routing system 100. Information provided by fleet routing system 100 may include traffic information, road quality information, construction information, current detour information, time of day information, day to day information (e.g., traffic may be decreased on Mondays and Fridays when more people work from home), vehicle information, GPS information, or any other information available to server device 135 and its associated artificial intelligence engine. Optimized route 440 may be optimized as discussed with respect to FIG. 1 but may be optimized to provide route 440 as the most efficient route in terms of the least time on the road and least mileage for the vehicle.

User interface 400 may further include information 425 with a list or an expected timeline of pickups, stops, and arrival at a location. For example, a user has selected a large bus and a large van for charter service along route 440. Both vehicles begin route 440 at Harris High School at 2 Main St., San Francisco, CA 94116 at 9:45 AM, arriving at 9:30 AM. The vehicles depart at 9:45 AM en route to Monroe High School at 43 Juniper St., San Francisco, CA 94110 by 10:07 AM with an intended departure at 10:15 AM. At 10:15 AM, the vehicles proceed to 34 Foulton Street, San Jose, CA, 94503 by 11:15 AM. An outbound trip itinerary may also be provided. Route 440 covers a distance of 50 miles over a duration of 1 hour and 45 minutes.

User interface 400 may further include an identification of the selected vehicles 430 and 435, which are a large bus and a large van along with associated costs to the user for the charter service, which in this case is a total of $2,779.10. At this point a user may confirm the ride and enter payment for the charter service.

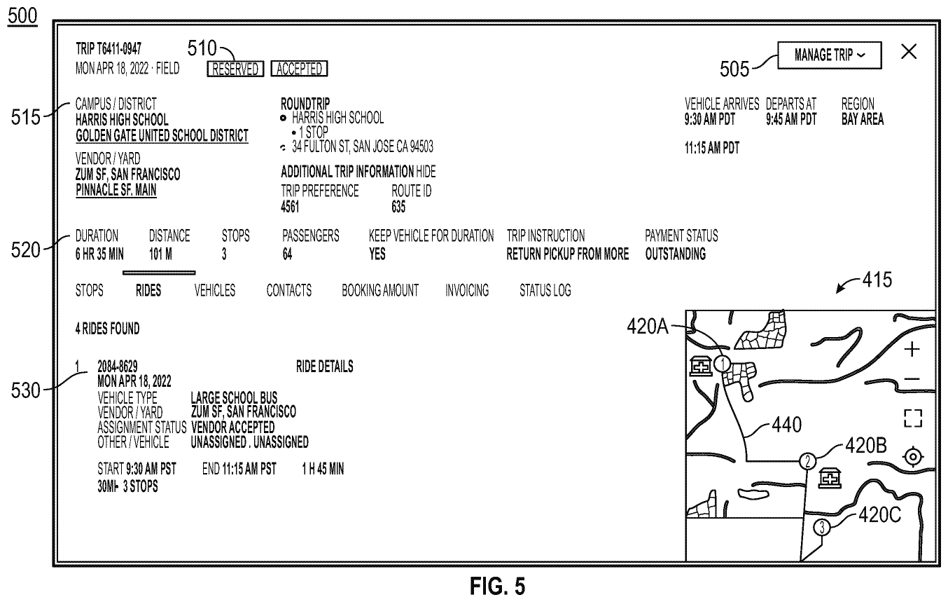

FIG. 5 illustrates an exemplary user interface 500 for assigning a vehicle for the charter service. User interface 500 may be provided to a service provider by provider device 130 to provide information about the requested trip. For example, server device 135 may assign a trip number and provide indicators 510 to the provider device 130 via user interface 400 that the trip has been reserved and accepted for service. A provider user may further have the option of interacting with button 505 to manage the trip by changing or adjusting specific details to better suit the charter service. User interface 500 may further provide information 515 about the trip including the start location, the stop locations, the destination, the type of trip, the trip timing information, or any other information relevant to the charter service request. User interface may further provide information 520 regarding the details, duration, number of stops, number of passengers, the selection to keep the buses and drivers for the duration of the trip (e.g., require the buses and drivers remain at the destination while the purpose of the activity is accomplished, trip instructions, and payment status.

Interface 500 may provide information relevant to the provider for providing the required vehicles and drivers at the time specified in the user request in graphical user interface 200. For example, server device 135 may review the available inventory and available vehicles for the particular charter service on Monday, Apr. 18, 2022, and determine that a particular large bus and a particular large van are available to provide the charter service. Server device 135 may further confirm with drivers that the drivers are available for Monday, Apr. 18, 2022, to provide the driving service for the charter service, including providing the drivers with information about the charter service, such as duration, number of stops, start time, and distance. A map 415 may be provided to provider user by provider device 130 which provides a graphical display of route 440 which illustrates a start location 420A, one or more stops 420B, and a destination 420C. Interface 500 may further identify vendors who own the large bus and the large van and the location of those vehicles. Information regarding the vendors and the location of the vehicles may be provided to a driver by server 135 communicating with driver device 120 via communication network 105.

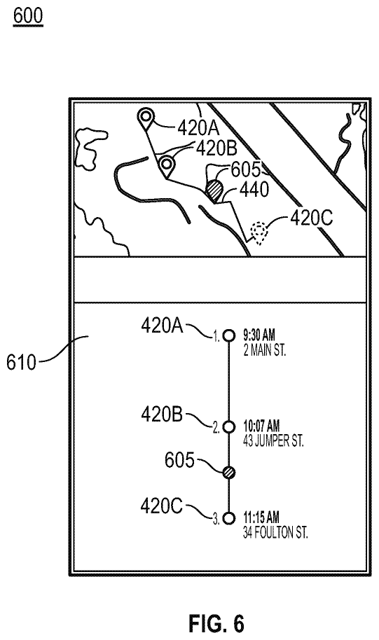

FIG. 6 illustrates a user interface 600 providing real time tracking information about the charter service. User interface 500 illustrates a map 415 with route 420, as shown in FIGS. 4 and 5. However user interface 600 is intended to be a real time view of the ride as it is in progress. As shown in user interface 600, a location icon 605 is provided on route 420 that illustrates where on the map the charter vehicle(s) is located in real time. This information may be relevant to an administrator user, a ride requestor user, a parental user, a provider user, or any other person associated with the charter service (e.g., a pastor of a church activity transporting youth for a Bible camp and the parents of the youth). GPS information provided from driver device 120 may, in turn, be provided to server device 135 which may update all other devices in fleet routing system 100, including administrator device 125, ride requestor device 110, user device 115, and provider device 130 to accurately display icon 605 in real time on route 440.

User interface 600 may further include a timeline view 610, which provides a view of a timeline for the charter service and a location of the charter vehicle in real time. For example, a pickup location is shown at stop 420A at 9:30 AM at 2 Main Street. A stop 420B is shown at 10:07 AM at 43 Juniper St. A destination 420C is shown at 11:15 AM at 34 Foulton St. Icon 605 may represent a real time location of the vehicle(s) associated with the charter service. As shown in FIG. 6, user interface 600 provides icon 605 on both map 415 and timeline view 610 in the same location representing a real time location of a vehicle associated with the charter service in two different ways.

The techniques described herein may provide significant benefit for both private and governmental entities. On the one hand, vehicle owners may increase utilization of their vehicles, manage their vehicle inventory, and utilization. At the same time, the public, public schools, private schools, and other groups benefit from provided ride charter services for athletic trips, field trips, extracurricular activities, and private events.

The foregoing description has been presented for the purposes of illustration and description. It is not intended to be exhaustive or to limit the disclosure to the precise form disclosed. Many modifications and variations are possible in light of the above disclosure and teachings. Further, it should be noted that any or all of the aforementioned alternate implementations may be used in any combination desired to form additional hybrid implementations of the disclosure. For example, components described herein may be removed and other components added without departing from the scope or spirit of the embodiments disclosed herein or the appended claims.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

1. A system, comprising:
a server device receiving a vehicle charter service request to privately transport six or more passengers in a single charter service affiliated with the vehicle charter service request, from a user device, the vehicle charter service request including information about the vehicle charter service request, including a user specified pick up location, one or more user specified stop locations, and a user specified destination location;
wherein the server device, in response to the vehicle charter service request provides, through a graphical user interface to the user device, one or more vehicle types which are selectable for providing the vehicle charter service, the one or more vehicle types including a bus,
wherein based on the user specified pickup location, the one or more user specified stop locations, and the user specified destination location, the server device creates an optimized route for the charter service at the time of the charter service request, the optimized route for the charter service being determined by the server device, the server device determining the optimized route for the charter service based on historical route information received from driver devices associated with previously completed ride service requests and real time information received from at least one of the driver devices associated with the vehicle charter service request,
wherein the server device further provides a map on a graphical user interface to the user device, the map including a visual representation of the route, the user specified pickup location, the one or more user specified stop locations, and the user specified destination location,
wherein the server device identifies an available vehicle from the one or more vehicle types selected for providing the vehicle charter service and a driver available for servicing the optimized route at the time of the vehicle charter service request,
wherein the server device transmits the optimized route via a graphical user interface to the at least one driver device, the graphical user interface including visual representations of the optimized route, the user specified pickup location, the user specified one or more stops, and the user specified destination, and
wherein the server device transmits real time global positioning system based tracking information for the available vehicle to the user device which includes an icon on the graphical user interface, the global positioning system based tracking information being received from the driver device by the server device while the available vehicle is servicing the route.

2. The system of claim 1, wherein the real time tracking information is provided via a graphical user interface transmitted by the server device to the user device and the driver device includes a map.

3. The system of claim 2, wherein the map includes visual representations of the optimized route, the specified pickup location, the specified one or more stops, and the specified destination.

4. The system of claim 3, wherein the map further includes an icon which visually represents a real time location of the available vehicle.

5. The system of claim 1, wherein the real time tracking information is provided via a graphical user interface transmitted by the server device to the user device and the driver device includes a timeline view.

6. The system of claim 5, wherein the timeline view includes visual representations of the specified pickup location, the specified one or more stops, and the specified destination.

7. The system of claim 6, wherein the timeline view further includes an icon which visually represents a real time location of the available vehicle.

8. The system of claim 7, wherein the timeline view further includes an icon which visually represents a real time location of each one of the available vehicles associated with the charter service request.

9. The system of claim 1 wherein the types of vehicles include multi-passenger vehicles.

10. The system of claim 9, wherein the types of vehicles selectable by the user further include a van, and a motorcoach.

11. The system of claim 10, wherein the server device provides a graphical user interface to the user device with pricing for each one of the one or more types of vehicles.

12. The system of claim 1, wherein a graphical user interface associated with the vehicle charter service request from the user device further includes an automatically populated arrival time for the one or more specified stop locations.

13. The system of claim 12, wherein the server device automatically transmits the arrival time based on the optimized route to the user device.

14. The system of claim 1, wherein a graphical user interface associated with the vehicle charter service request from the user device further includes an interface for receiving from the user device, trip purpose information.

15. The system of claim 1, wherein the server device provides a graphical user interface to the user device that is associated with the vehicle charter service request and receives an indication from the user device which specifies that the charter service request is a round trip charter service request.

16. The system of claim 1, wherein the server device provides a graphical user interface to the user device that is associated with the vehicle charter request service request and receives an indication from the user device which specifies that the charter service request is a one-way charter service request.

17. The system of claim 1, wherein the server device provides through the graphical user interface to the user device one or more vehicle types which are selectable for providing the vehicle charter service further provides a quantity selector which provides an indication of how many of the one or more vehicle types are requested for the vehicle charter service.

18. The system of claim 1, wherein server device provides a graphical user interface that indicates a total cost of a requested vehicle charter service.

19. The system of claim 1, wherein the server device determines that an available vehicle is available based on known schedules for each vehicle in a fleet of vehicles.

20. The system of claim 19, wherein the server device assigns the available vehicle and the available driver to service the route and provides the available driver with a location of the available vehicle.
